(19) United States
(12) Patent Application Publication
(10) Pub. No.: US 2015/0193217 A1
(43) Pub. Date: Jul. 9, 2015

(54) WEARABLE DEVICES AND SYSTEMS AND METHODS FOR WEARABLE DEVICE APPLICATION MANAGEMENT THEREOF

(71) Applicant: MediaTek Singapore Pte. Ltd., Singapore (SG)

(72) Inventors: Keyu XIANG, Chengdu (CN); Yupeng ZHOU, Sichuan (CN); Wei PI, Chengdu (CN); Yun YI, Chengdu (CN)

(21) Appl. No.: 14/591,288

(22) Filed: Jan. 7, 2015

(30) Foreign Application Priority Data
Jan. 7, 2014 (CN) 201410006734.0
Jun. 11, 2014 (CN) 201410258393.6
Jan. 6, 2015 (CN) 201510005675.X

(51) Int. Cl. G06F 9/445; G06F 9/44

(52) U.S. Cl. CPC G06F 8/61; G06F 8/62; G06F 8/71

(57) ABSTRACT

An application installation method of a wearable device is provided. The application installation method of a wearable device includes the steps of: receiving an installation application package from a smart device via a wireless transmission, wherein the installation application package is used for installing an application; parsing the installation application package to obtain an application installation file corresponding to the application; and using the application installation file to install the application on the wearable device.

### CROSS REFERENCE TO RELATED APPLICATIONS

This application claims priority of China Patent Application No. 201410006734.0, filed on Jan. 7, 2014, China Patent Application No. 201410258393.6, filed on Jun. 11, 2014, and China Patent Application No. (not yet assigned), filed on Jan. 6, 2015, and the entirety of which are incorporated by reference herein.

### BACKGROUND OF THE INVENTION

1. Field of the Invention

The disclosure relates generally to mobile communications and, more particularly, to wearable devices and methods for the installation and uninstallation of applications.

2. Description of the Related Art

With the development of mobile communication technology, applications of wearable devices (e.g., glasses, watches, etc.) have become more and more popular. To achieve extension of the wearable device applications, a wearable device terminal is usually required to connect to PC via a wired cable or via a removable memory card to download an application and then install it. This approach, however, requires to increase the number of device-side interfaces, and makes the wearable device less portable and cost more.

Therefore, there is a need for application extension and uninstallation methods for the wearable device to make the wearable device more portable and cost less.

### BRIEF SUMMARY OF THE INVENTION

Wearable devices and systems and methods for wearable device application management thereof are provided.

In an embodiment, an application installation method of a wearable device is provided. The application installation method of the wearable device includes the steps of: receiving an installation application package from a smart device via a wireless transmission, wherein the installation application package is used for installing an application; parsing the installation application package to obtain an application installation file corresponding to the application; and using the application installation file to install the application on the wearable device.

In another embodiment, an application uninstallation method of a wearable device is provided. The application uninstallation method of the wearable device includes the steps of: receiving an uninstallation application package (APK) from a smart device through a wireless transmission, wherein the uninstallation application package is used for uninstallation of an application; parsing the uninstallation application package to obtain an application uninstallation file corresponding to the application; and using the application uninstallation file to uninstall the application on the wearable device.

Another embodiment of a wearable device includes a wireless transmission module and a parser module. The wireless transmission module is arranged for receiving an installation/uninstallation application package (APK) from a smart device. The parser module is arranged for parsing the installation/uninstallation application package to obtain an installation/uninstallation file, wherein the installation/uninstallation file corresponds to an application; wherein the parser module further uses the installation/uninstallation file to install/uninstall the application on the wearable device.

Another embodiment of a smart device includes a file system, an application management module and a wireless transmission module and a parser module. The file system is arranged for storing configuration file information of third-party applications with prescribed format. The application management module is arranged for reading and parsing the configuration file information. The wireless transmission module is arranged for transmitting the parsed configuration file information.

In another embodiment, a method for pushing wearable-platform applications to a wearable device is provided. The method includes the steps of: initializing supporting applications of the wearable device; reading configuration files from a predefined path and parsing the configuration files, wherein applications required to be installed on the wearable device are obtained by parsing the configuration files; entering an application list of the wearable device and querying for an installation status for the application list based on the configuration files; and determining whether to install or uninstall a wearable device application on the wearable device according to the queried installation status thereof.

Another embodiment of a system for application management includes a smart device and a wearable device. The smart device is arranged for providing an installation/uninstallation application package (APK) and transmitting the installation/uninstallation application package via a wireless transmission, wherein the installation/uninstallation application package further comprises an installation/uninstallation file corresponding to an application. The wearable device is arranged for receiving the installation/uninstallation application package from the smart device via the wireless transmission, parsing the installation/uninstallation application package to obtain the application installation/uninstallation file corresponding to the application, and using the application installation/uninstallation file to install/uninstall the application on the wearable device.

Other aspects and features of the present invention will become apparent to those with ordinary skill in the art upon review of the following descriptions of specific embodiments of the wearable devices, and systems for carrying out the wearable device APP management methods.

### BRIEF DESCRIPTION OF THE DRAWINGS

The invention will become more fully understood by referring to the following detailed description with reference to the accompanying drawings, wherein:

FIG. 1 is a schematic diagram illustrating an architecture including a wearable device and a smart device according to an embodiment of the invention;

FIG. 2 is a flowchart of an application installation method of a wearable device according to an embodiment of the invention;

FIG. 3 is a flowchart of data and commands reception of the wearable device according to an embodiment of the invention;

FIG. 4 is a schematic diagram illustrating a pushing and installation process from the smart device to the wearable device according to an embodiment of the invention;

FIG. 5 is a flowchart of an application uninstallation method a wearable device according to an embodiment of the invention;

FIG. 6 is a schematic diagram illustrating an uninstallation process on the wearable device according to an embodiment of the invention;

FIG. 7 is a flowchart illustrating an implementation of installation status synchronization of the wearable device according to an embodiment of the invention;

FIG. 8 is a flowchart of a method for communicating with the smart device by the wearable device according to an embodiment of the invention;

FIG. 9 is a schematic diagram illustrating an operational flow for the wearable device at the smart device according to an embodiment of the invention;

FIG. 10 is a schematic diagram illustrating a brief structure of extracting LinkIt APPs from a third-party smart device and pushing the LinkIt APPs to the wearable device performed by a LinkIt APP management application according to an embodiment of the invention; and

FIG. 11 is a flowchart of a method of extracting LinkIt APPs from a third-party smart device and pushing the LinkIt APPs to the wearable device performed by a LinkIt APP management application according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

It should be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, the formation of a first feature over or on a second feature in the description that follows may include embodiments in which the first and second features are formed in direct contact, and may also include embodiments in which additional features may be formed between the first and second features, such that the first and second features may not be in direct contact.

One embodiment of the present invention is the use of short-range communication protocols, such as Bluetooth™ (BT) protocol transmission technology, wherein a BT module with lower-cost is served as hardware carrier at the wearable device side, and at the smart device such as an Android™ client device side, a packaged installation application package (Android™ package, APK), such as LinkIt application (APP) installation package is first installed and the LinkIt APP file data is then quickly and automatically pushed to the a wearable device through the installation package to complete the automatic installation.

It should be understood that although the LinkIt application is used as an example for illustration of the embodiments of the present invention, but a person with ordinary skill in the art can understand that installation packages corresponding to other platforms may also be applied to embodiments of the invention. The LinkIt platform is a mobile application development platform similar to the JVM, Brew, which supports dynamic link library that can smoothly run the application from the peripheral memory card. Meanwhile, LinkIt platform is formed by an abstraction layer (SAL), a Framework and LinkIt application programming interfaces (APIs), wherein the abstraction layer and the Framework form a complete operating environment, in which the Framework can be built on top of the abstraction layer, which implements LinkIt core functions, such as memory management, dynamic link and so on. The LinkIt application can call into the Framework APIs and LinkIt platform APIs through the LinkIt APIs, thus enabling rich functionality. The invention can be more fully understood by reading the subsequent detailed description and examples with reference to the accompanying drawings.

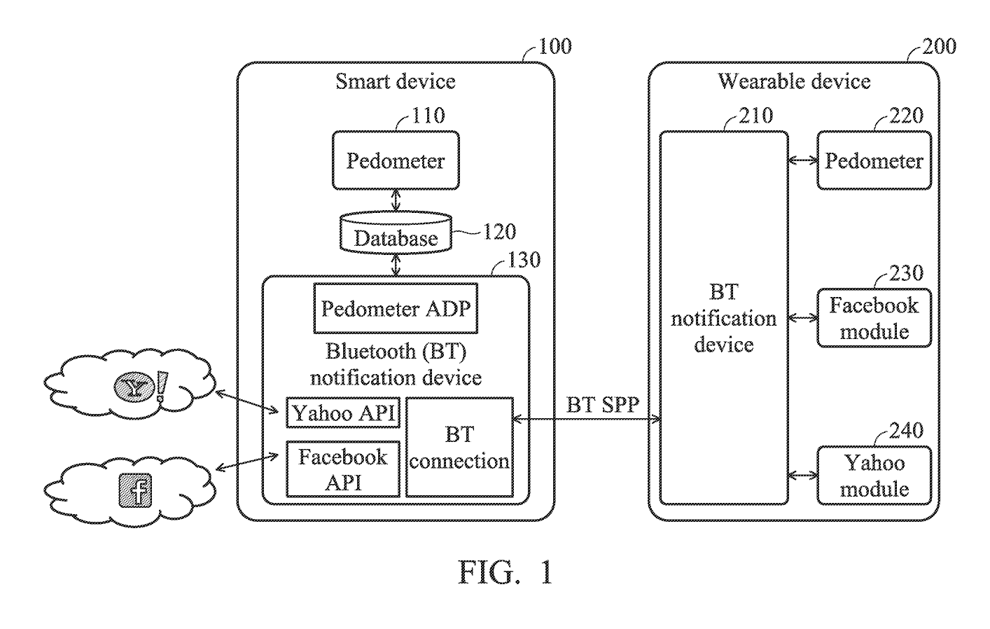

FIG. 1 is a schematic diagram illustrating an architecture including a wearable device and a smart device according to an embodiment of the invention, such as Android™ client device side. The smart device 100 may be a mobile phone, a smartphone, a tablet PC, a Portable Media Player (PMP), a handheld gaming console and so on. As shown in FIG. 1, the smart device 100 may comprise a pedometer 110, a database 120, and a Bluetooth (BT) notification device 130, wherein the BT notification device 130 further comprises a pedometer adapter (ADP) connected to the database, a BT connection module, and optionally contains applications provided by third parties, such as the Facebook API for instant messaging, MSN, QQ, Wechart, Weibo and so on, as well as other applications with real-time notifications or other features, such as Yahoo API and so on. Taking the Yahoo API and Facebook API as an example, the Yahoo API and Facebook API may further be coupled to a server of a third-party application provider through a wireless or wired connection, to implement the corresponding operations, separately. Correspondingly, the wearable device 200 may also comprise a BT notification device 210 coupled to the BT connection module, a pedometer 220, a Facebook module 230, and a Yahoo module 240 and the like. It should be understood that persons skilled in the art can understand that the above-described modules or APIs can be implemented by hardware or software modules, and the invention is not limited thereto.

According to one embodiment of the invention, during the application (APP) installation process of the smart device 100 and the wearable device 200, the smart device 100 first downloads a packaged installation application package, e.g., a LinkIt APP, then connects to the wearable device 200 through a wireless transmission, such as a BT, IEEE802.11, HomeRF technology, IrDA, ZigBee or Wifi connection. Before entering into the push and install or uninstall procedure, the installation package is packed with encrypted synchronization (“SYNC”) command and sent to the wearable device 200 via a short-range communication, e.g., via BT or other short-range communications. After receiving the command, after decryption and unpacking of the received package, the wearable device 200 can identify the synchronization command and install the application, and then return an APP list of APPs installed to the smart device 100, so as to achieve synchronization in installation status. Specifically, before the smart device 100 initiates a push and installation operation, the installation package will assemble the respective APP file format, size and other information together through the install command, and then encrypt the assembled data and pack the encrypted data to a package. The package is then sent to the wearable device 200 via BT or other forms of wireless transmission. After receiving the package, through the decryption and unpacking process for the received package, the wearable device 200 identifies the installation command from the received package and parses out the APP file format, size and other information from it, and informs the smart device 100 to start the transmission of APP data. The wearable devices 200 may also simultaneously receive data and save it to a file. When the wearable device 200 has completed the receiving process, the wearable device 200 automatically completes the installation of the received APP via the installation package, e.g., the LinkIt processing functionality, and after the installation process is complete, notifies the smart device 100 to complete the status updates.

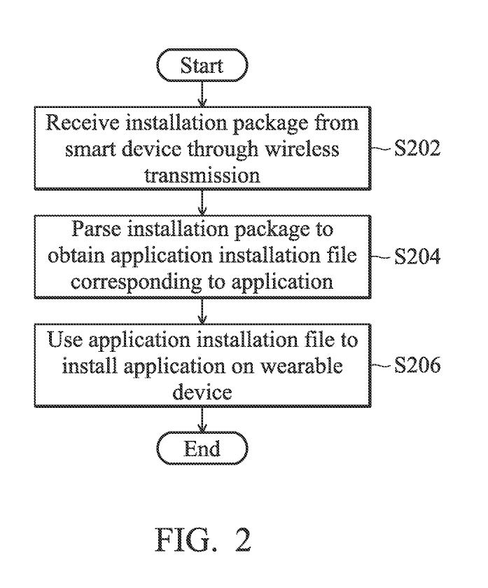

FIG. 2 is a flowchart of an application installation method of a wearable device according to an embodiment of the invention. The application installation method of a wearable device can be applied to a wearable device, such as the wearable device 200 shown in FIG. 2. The application installation method of the wearable device comprises the following steps. First, an installation package sent from a smart device (e.g., the smart device 100) is received through a wireless transmission, such as BT, IEEE802.11, HomeRF technology, IrDA, ZigBee, or Wifi wireless transmission (step S202), wherein the installation package is used for installation of an application. Then, the installation package is parsed to obtain an application installation file corresponding to the application (step S204). After obtaining the application installation file corresponding to the application, the application installation file is used to install the application on the wearable device (step S206).

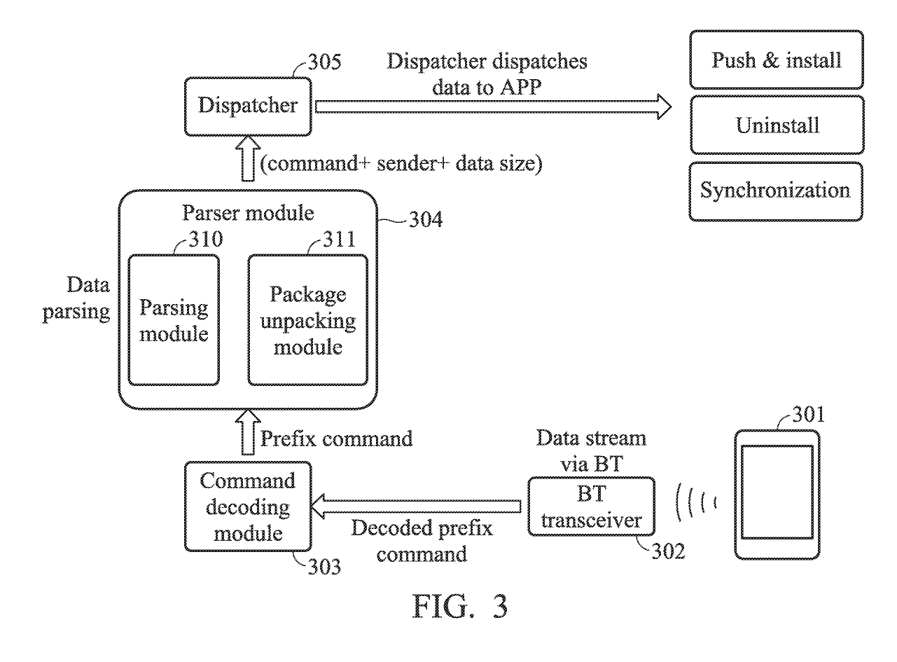

FIG. 3 is a flowchart of data and commands reception of the wearable device according to an embodiment of the invention. As shown in FIG. 3, the smart device, e.g., the Android client device 301, first transmits data to the BT transceiver 302 via the BT communication, and then the command decoding module 303 decodes the encrypted prefix command in the data stream received from the BT transceiver 302 and then sends the decoded prefix command to the parser module 304. After processing of the parser module 304, the command obtained from the parsing process, the sender and data size information is passed to the dispatcher 305. The dispatcher 305 then sends commands that correspond to different operations to the wearable device to implement the corresponding operation, for example, push & install, uninstall and synchronization and so on. It should be noted that the parser module 304 may further comprise a parsing module 310 and a package unpacking module 311, respectively for implementing parsing, package unpacking or the like operation.

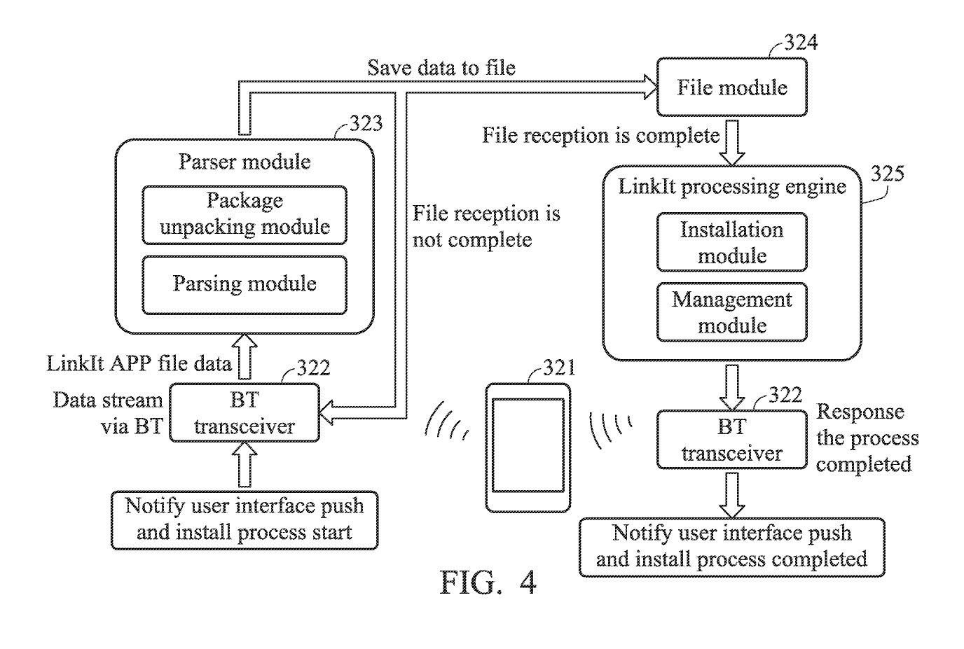

FIG. 4 is a schematic diagram illustrating a pushing and installation process from the smart device to the wearable device according to an embodiment of the invention. A smart device 321, such as an Android client device, first encrypts and packs information regarding a LinkIt APP to be installed, such as file format, file size and other information and transmits the encrypted and packed information to the BT transceiver 322 via the BT communication. Then, the command decoding module (not shown) decodes the information regarding the LinkIt APP to be installed in the data stream received from the BT transceiver 322, and transmits the decoded data to the parser module 323. After the operations of first unpacking the decoded data and then parsing the unpacked data, the parser module 323 sends the file information obtained from the unpacking and parsing processes to the file module 324 to notify it. Meanwhile, the user interfaces (UI) of the smart device 100 and the wearable device 200 can simultaneously display the progress of the push and install process. If the file module 324 does not complete the file reception, the BT transceiver 322 continues to receive data until the file module 324 completes the file reception. After the file reception is complete, the file module 324 inputs the LinkIt APP file information into the LinkIt processing engine 325. Upon receiving the installation request, the LinkIt processing engine 325 unpacks the LinkIt APP and performs the installation of the LinkIt APP. When the entire process is completed, the wearable device displays the installation result on the UI, and returns the installation result to the smart devices 321 via the BT transceiver 322, so that the smart device 321 can simultaneously update the UI display.

According to another embodiment of the invention, during the APP (e.g., LinkIt APP) uninstallation process of the wearable device, the smart device 100 first downloads the packaged LinkIt APP installation package, then connects to the wearable device 200 through a wireless transmission, such as BT or other wireless connection, when the installation is completed. Before entering into the push and install or uninstall procedure, the installation package is packed with an encrypted “SYNC” command and sent to the wearable device 200 via BT communication. After receiving the command, after decryption and unpacking of the received package, the wearable device 200 can identify the synchronization command and return an APP list of installed APPs to the smart device, so as to achieve synchronization in installation status. Specifically, when the smart device 100 initiates an uninstallation operation, the installation package will assemble information of the LinkIt APP to be uninstalled with the uninstall command, and then encrypt the assembled data and pack the encrypted data to a package. The package is then sent to the wearable device 200 via BT or other forms of wireless transmission. After receiving the package, through a decryption and unpacking process for the received package, the wearable device 200 identifies the uninstall command from the received package and parses out the information of the LinkIt APP to be uninstalled from it, and passes the parsed information to the LinkIt processing engine and then automatically completes the uninstallation of the LinkIt APP by the LinkIt processing engine. After the uninstallation process is completed, the wearable device notifies the smart device to complete the status updates.

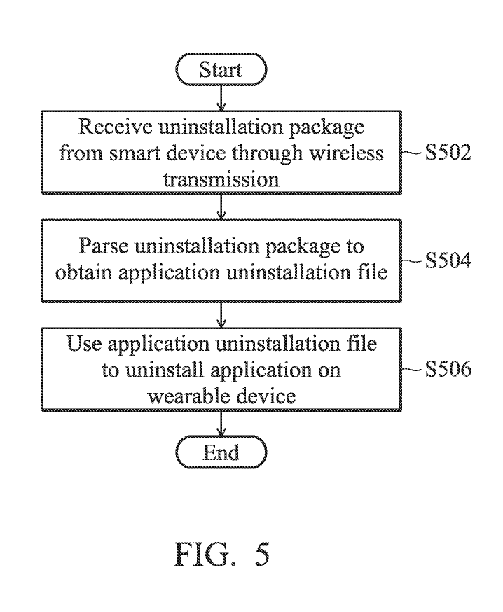

FIG. 5 is a flowchart of an application uninstallation method for a wearable device according to an embodiment of the invention. The application uninstallation method of the wearable device comprises the following steps. First, an uninstallation package is received from a smart device through a wireless transmission, such as BT connection device or connection devices using other wireless transmissions (step S502), wherein the uninstallation package is used for uninstallation of an application. Then, the uninstallation package is parsed to obtain an application uninstallation file corresponding to the application (step S504). After obtaining the application uninstallation file, the application uninstallation file is used to uninstall the application on the wearable device (step S506).

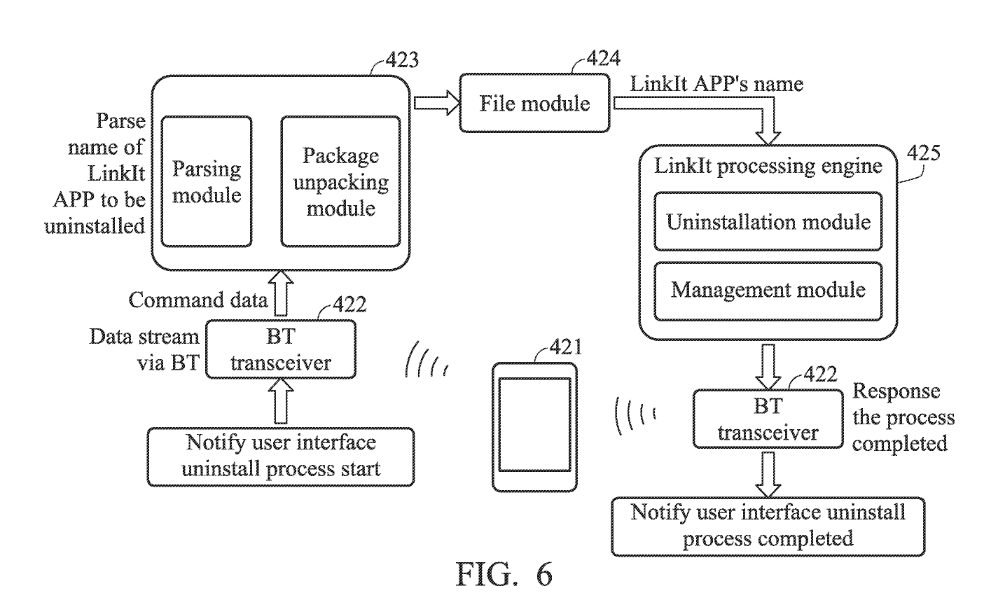

FIG. 6 is a schematic diagram illustrating an uninstallation process on the wearable device according to an embodiment of the invention. A smart device 421, e.g., the Android client device, first assembles the uninstall command with data, such as the file format, file size and other information, encrypts the assembled data, packs the encrypted data to a package and then transmits the package to the BT transceiver 422 via the BT communication. Then, the command decoding module (not shown) decodes the information of the LinkIt APP to be uninstalled in the data stream received from the BT transceiver 422 and then sends the decoded data to the parser module 423. After unpacking and parsing the decoded data, the file information obtained from the unpacking and parsing processes is sent to the file module 424 to notify it. Meanwhile, the user interfaces (UI) of the smart device 421 and the wearable device can simultaneously display the progress of the uninstall process. If the file module 424 does not complete the file reception, the BT transceiver 422 continues to receive commands and data until the file module 424 completes the file reception. After the file reception is completed, the file module 424 inputs the LinkIt APP file information (e.g., the LinkIt APP's name) into the LinkIt processing engine 425.

The LinkIt processing engine 425 can perform respective processing, such as LinkIt APP downloading and other processing at the wearable device side according to the received file information (such as downloading information of the LinkIt APP). When the entire process is completed, the wearable device displays the uninstallation result on the UI screen, and returns the uninstallation result to the smart devices 421 via the BT transceiver 422, such that the smart device 421 can simultaneously update its UI display.

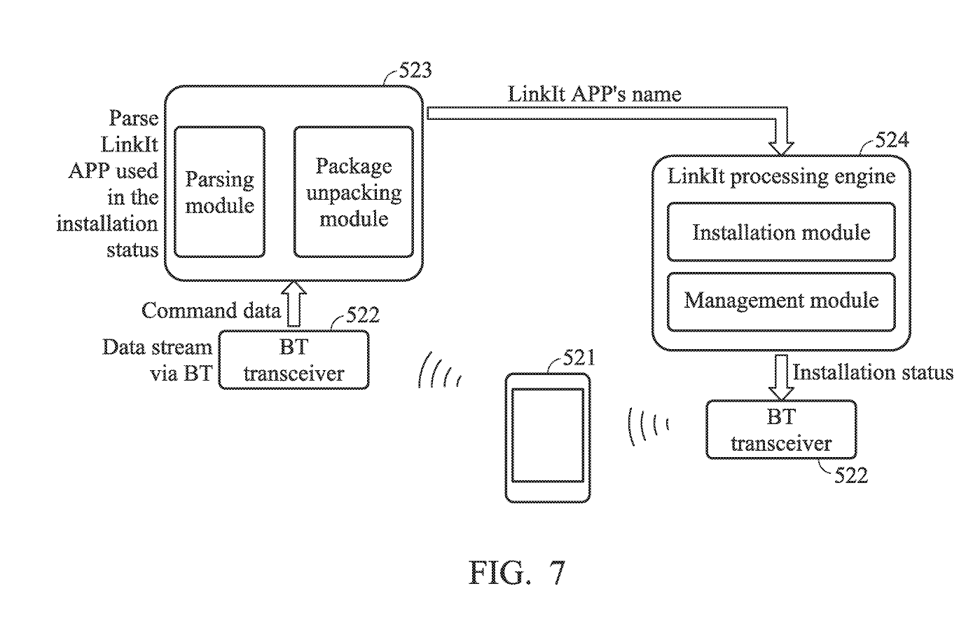

FIG. 7 is a flowchart illustrating an implementation of installation status synchronization of the wearable device according to an embodiment of the invention. A smart device 521, e.g., the Android client device, transmits the LinkIt APP status data stream to the BT transceiver 522 via the BT communication. Then, the command decoding module (not shown) decodes the information of the LinkIt APP to be installed in the data stream received from the BT transceiver 522 and then sends the decoded data to the parser module 523. After unpacking and parsing the decoded data, the file information (e.g., the LinkIt APP's name) obtained from the unpacking and parsing processes is sent to the LinkIt processing engine 524. Meanwhile, the user interfaces (UI) of the smart device 521 and the wearable device can simultaneously display the information of the installation status. After receiving the parsed result, the LinkIt processing engine 524 can transmit the information of the installation status to the BT transceiver 522.

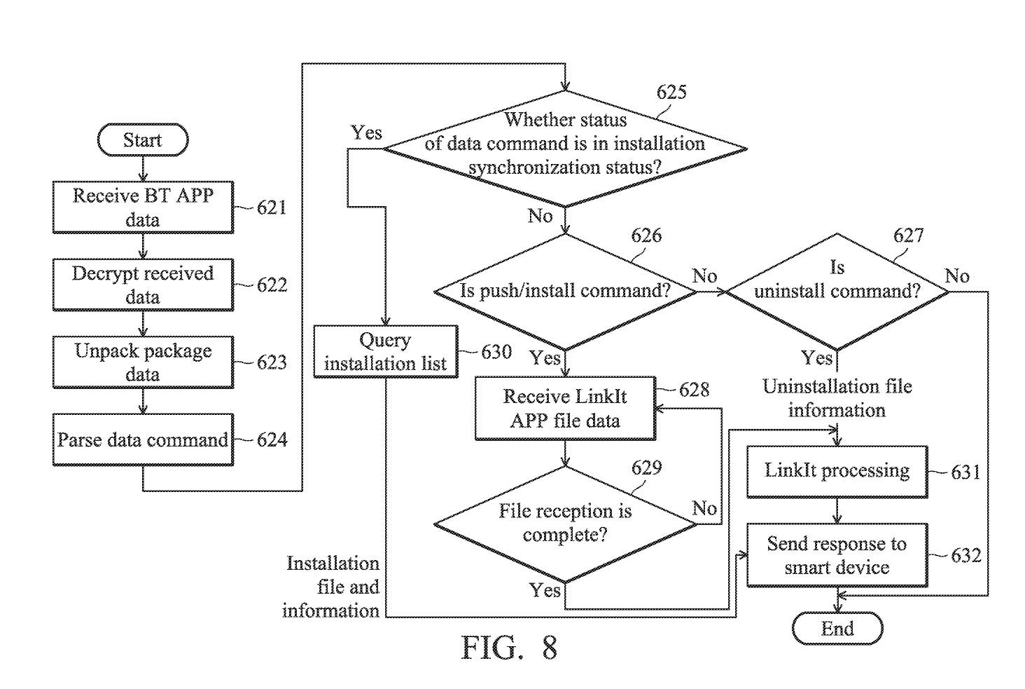

FIG. 8 is a flowchart of a method for communicating with the smart device by the wearable device according to an embodiment of the invention. As shown in FIG. 8, in step 621, a wearable device receives BT APP data from a mobile terminal (e.g., a smart device) and then in step 622, it decrypts the received data. Thereafter, in step 623, the wearable device unpacks the package data, and in step 624, it parses the data command from the unpacked data. For the parsed command, the wearable device further determines, in step 625, whether the status of the parsed data command is in an installation synchronization status. If so, the wearable device queries an installation list in step 630 and transmits a response to the smart device in step 632.

If it is determined that the status of the parsed data command is not in the installation synchronization status in step 625, the wearable device further determines, in step 626, whether the parsed data command is the push/install command, and if so, it receives the installation file, such as LinkIt APP file data, in step 628. When the file reception is complete (Yes in step 629), the wearable device obtains the installation file information, and enters the installation process, e.g., performing LinkIt processing corresponding to the LinkIt. If it is determined that the parsed data command is not the push/install command in step 626, the wearable device further determines, in step 627, whether the parsed data command is the uninstall command and if so, it passes the uninstallation file information and go to step 631 to perform the LinkIt processing. Otherwise, the process ends. After the LinkIt processing has been entered, the wearable device can send a response to the smart device in step 632 after the LinkIt processing is completed.

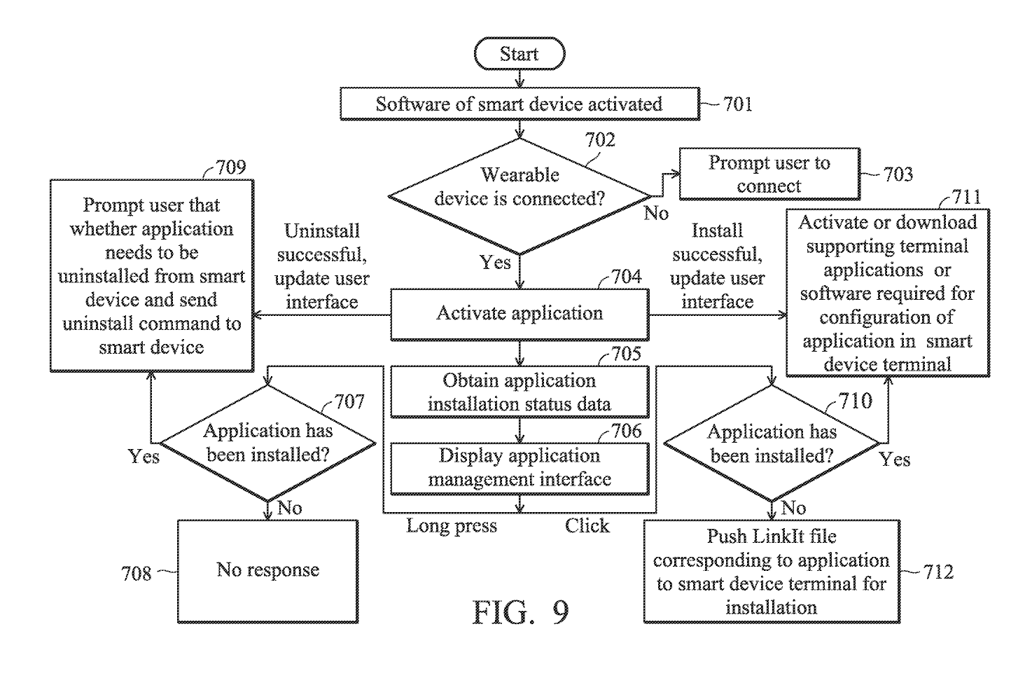

FIG. 9 is a schematic diagram illustrating an operational flow for the wearable device at the smart device according to an embodiment of the invention. First, in step 701, software of the smart device is activated, then in step 702, it determines whether the wearable device is connected. If not, the user is prompted to connect (step 703); if so, then the application is activated in step 704, and obtains the application installation status data in step 705. Then, in step 706, the application management interface is displayed on, for example, MMI, touch screen, or any visible interface. In this interface, if it is detected a selection signal for any application record, e.g., a click signal, it is further determined whether the application has been installed in step 710, and if so, in step 711, supporting terminal applications (such as sports statistics software) or software required for configuration (such as setting the city in Yahoo weather or logging-in to Facebook, etc.) of the application is activated or downloaded in the smart device terminal (such as a smartphone). If the application has not been installed, in step 712, the LinkIt file (which is already pre-packaged or downloaded and stored) corresponding to the application is pushed to the smart device terminal for installation, and waits for the smart device to return the result. If the installation was successful, the application management interface in step 706 will be updated. If it is detected that the selection signal for the application record is a long-press signal, it is further determined whether the application has been installed in step 707, and if so, in step 709, it is prompted to the user that whether or not the application needs to be uninstalled from the smart device and then the uninstall command is sent to the smart device and waits for the smart device to return the result. If the uninstallation was successful, the application management interface in step 706 will be updated. If the application is not installed, in step 708, no response will be given.

In addition, Embodiments of the invention further provides a method for extraction of the LinkIt APP from the smart device. As described above, the wearable device, configured on the platform LinkIt, can run a variety of applications, wherein such applications are collectively referred to as LinkIt APPs. For the installation method of the LinkIt APP on the LinkIt platform, the smart device pushes the LinkIt APP to the wearable device and installs it on the wearable device. Because there are very few platforms for the smart device to obtain the LinkIt APPs, there are more platforms for it to obtain its own corresponding applications, and thus it is more convenient for users to obtain. Therefore, based on the aforementioned features, in the invention, the LinkIt APPs are packaged in the smart device applications, and the LinkIt APPs can be extracted from the smart device applications and pushed to the wearable device. The specific process is as follows: packing the LinkIt APPs in the smart device applications; then by protocol, enabling the LinkIt APP management application on the smart device platform to acquire required LinkIt APP that can be pushed and installed from other smart device applications; and finally, pushing the LinkIt APPs to the wearable device.

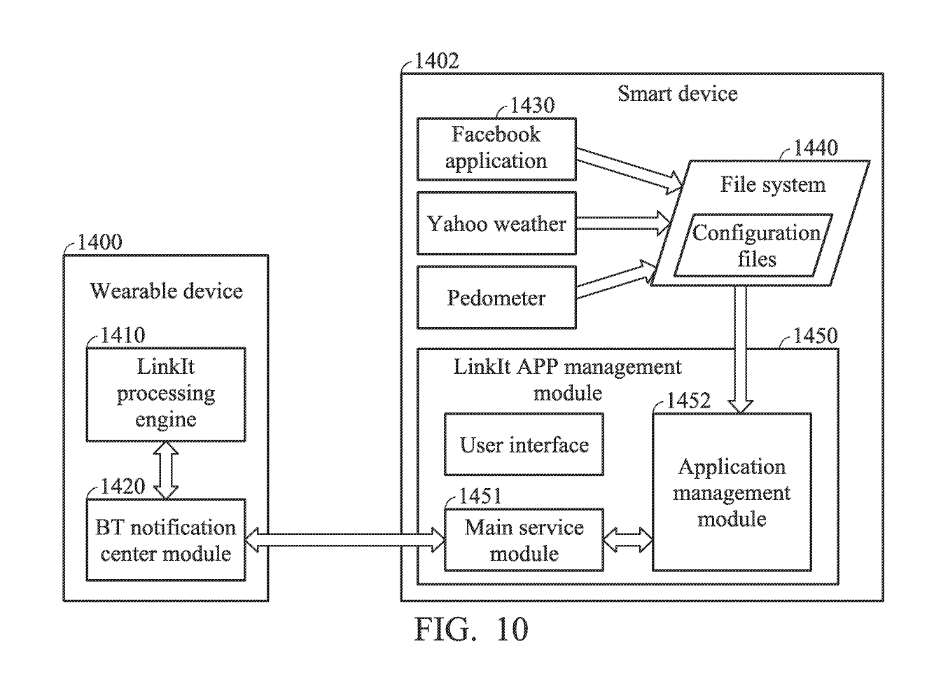

FIG. 10 is a schematic diagram illustrating a brief structure of extracting LinkIt APPs from a third-party smart device and pushing the LinkIt APPs to the wearable device performed by a LinkIt APP management application according to an embodiment of the invention. As shown in FIG. 10, in the smart device 1402, third-party applications 1430, such as Facebook applications, Yahoo weather and so on, writes predefined configuration file information and packaged LinkIt APP to the file system 1440 of the smart device according to prescribed format. The application management module 1452 of the LinkIt APP management application module 1450 reads the respective configuration files and LinkIt APP files from the file system 1440. The LinkIt APP management application module 1450, by parsing the configuration file, will be able to present the LinkIt APPs that can be pushed on the user interface for viewing by users. Users can push the LinkIt APP to the wearable device 1400 using interface operations through the main service module 1451. The wearable device 1400 receives the LinkIt APP via the BT notification center module 1420 and installs the LinkIt APP on the wearable device through the LinkIt processing engine 1410.

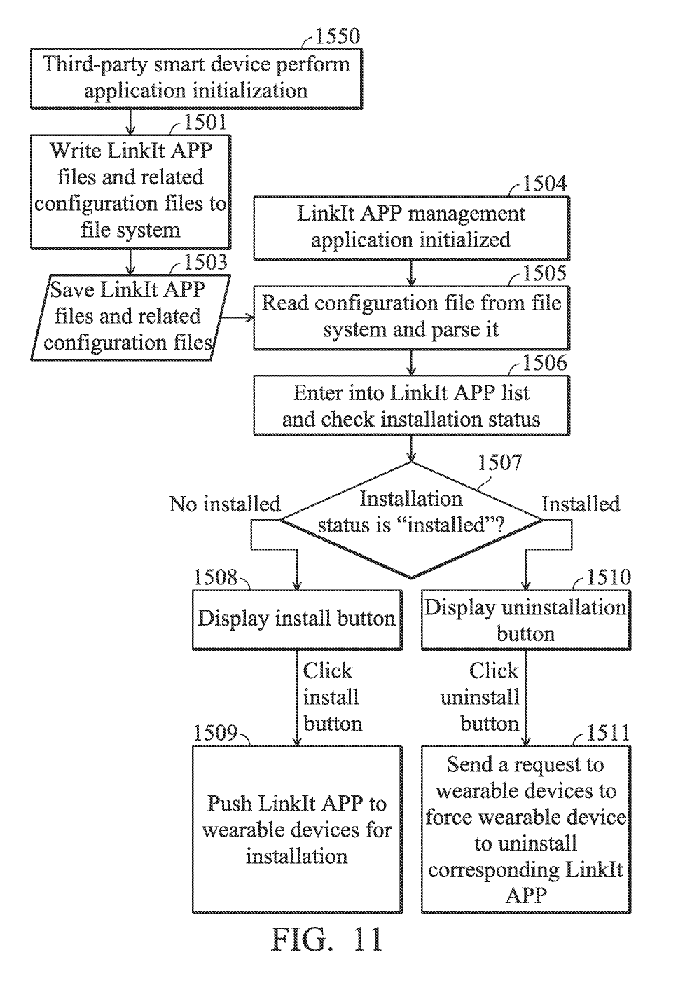

FIG. 11 is a flowchart of a method of extracting LinkIt APPs from a third-party smart device and pushing the LinkIt APPs to the wearable device performed by a LinkIt APP management application according to an embodiment of the invention. First, in step 1500, the third-party smart device performs application initialization, and then, in step 1501, writes the LinkIt APP files and related configuration files to the file system. Then, in step 1503, the file system saves the LinkIt APP files and related configuration files. In step 1504, the LinkIt APP management application is initialized, and then proceeds to step 1505, reads the configuration file from the file system based on a fixed path, parses it and displays the corresponding interface to the user based on the parsed data. After the user enters the interface, i.e., in step 1506, the user enters into a LinkIt APP list and checks or queries the installation status. In step 1507, it is determined whether to install a LinkIt APP according to the installation status obtained. If the queried installation status is “not installed”, the process proceeds to step 1508, an install button is displayed on the user interface, and when the install button is clicked by the user, the process proceeds to step 1509 to push the LinkIt APP to the wearable devices to force the wearable device to install the LinkIt APP. If the queried installation state is “installed”, the process proceeds to step 1510, an uninstall button is displayed on the user interface, and when the uninstall button is clicked by the user, the process proceeds to step 1511 to send a request to the wearable devices to force the wearable device to uninstall the corresponding LinkIt APP.

According to the embodiments of the invention, the smart device, such as Android terminal, and the wearable device can easily achieve synchronization control of automatic installation or uninstallation of the LinkIt APP on the wearable device and automatic synchronization of an installed LinkIt APP list. One of the beneficial effects is that the automatic installation and uninstallation of APPs on the wearable devices can be achieved through this technology without requiring a physical connection to the wearable device or memory card support, thereby reducing the cost of the wearable device. On the other hand, embodiments of the invention can extend a wide variety of LinkIt applications on the wearable device, thus facilitating the LinkIt promotion on the wearable device.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An application installation method of a wearable device, comprising:
receiving an installation application package (APK) from a smart device through a wireless transmission, wherein the installation application package is used for installation of an application;
parsing the installation application package to obtain an application installation file corresponding to the application; and
using the application installation file to install the application on the wearable device.

2. The application installation method of claim 1, wherein parsing the installation application package to obtain the application installation file corresponding to the application further comprises:
decrypting the installation application package to obtain a decrypted installation application package; and
parsing the decrypted installation application package to obtain the application installation file.

3. The application installation method of claim 2, wherein the decrypted installation application package further comprises an installation command, and the wearable device uses the application installation file to install the application in response to the installation command.

4. The application installation method of claim 1, further comprising:
after the application is completely installed, returning an installation list to the smart device by the wearable device, so that the smart device synchronously updates an installation status of the application.

5. The application installation method of claim 1, further comprising:
during the application installation process, returning an installation status for the simultaneously display an installation progress of the application on the smart device.

6. An application uninstallation method of a wearable device, comprising:
receiving an uninstallation application package (APK) from a smart device through a wireless transmission, wherein the uninstallation application package is used for uninstallation of an application;
parsing the uninstallation application package to obtain an application uninstallation file corresponding to the application; and
using the application uninstallation file to uninstall the application on the wearable device.

7. The application uninstallation method of claim 6, wherein parsing the uninstallation application package to obtain the application uninstallation file corresponding to the application further comprises:
decrypting the uninstallation application package to obtain a decrypted uninstallation application package; and
parsing the decrypted uninstallation application package to obtain the application uninstallation file.

8. The application uninstallation method of claim 7, wherein the decrypted uninstallation application package further comprises an uninstallation command, and the wearable device uses the application uninstallation file to uninstall the application in response to the uninstallation command.

9. The application uninstallation method of claim 6, further comprising:
after the application is completely uninstalled, returning an updated installation list to the smart device by the wearable device, so that the smart device synchronously updates an uninstallation status of the application.

10. The application uninstallation method of claim 6, further comprising:
during the application uninstallation process, returning an uninstallation status for device to simultaneously display an uninstallation progress of the application on the smart device.

11. A wearable device, comprising:
a wireless transmission module for receiving an installation/uninstallation application package (APK) from a smart device; and
a parser module for parsing the installation/uninstallation application package to obtain an installation/uninstallation file, wherein the installation/uninstallation file corresponds to an application;
wherein the parser module further uses the installation/uninstallation file to install/uninstall the application on the wearable device.

12. The wearable device of claim 11, wherein the parser module further comprises:
a parsing module for parsing the installation/uninstallation application package; and
an unpacking module for unpacking the parsed installation/uninstallation application package.

13. The wearable device of claim 11, further comprising:
after the application is completely installed/uninstalled, the wearable device returns an updated installation list to the smart device, so that the smart device synchronously updates an installation/uninstallation status of the application.

14. The wearable device of claim 11, further comprising:
during the application installation/uninstallation process, the wearable device returns an installation/uninstallation status for the application being installed/uninstalled to the smart device to simultaneously display an installation/uninstallation progress of the application on the smart device.

15. A smart device, comprising:
a file system for storing configuration file information of third-party applications with prescribed format;
an application management module for reading and parsing the configuration file information; and
a wireless transmission module for transmitting the parsed configuration file information.

16. The smart device of claim 15, wherein the application management module further comprises an interface for presenting an application corresponding to the parsed configuration file information.

17. The smart device of claim 16, wherein the application management module further comprises a main service module for pushing the application to a wearable device.

18. A method for pushing wearable-platform applications to a wearable device, comprising:
initializing supporting applications of the wearable device;
reading configuration files from a predefined path and parsing the configuration files, wherein applications required to be installed on the wearable device are obtained by parsing the configuration files;
entering an application list of the wearable device and querying for an installation status for the application list based on the configuration files; and
determining whether to install or uninstall a wearable device application on the wearable device according to the queried installation status thereof.

19. The method of claim 18, further comprising:
writing the wearable-platform applications and the configuration files to the predefined path of a file system by using applications of third-party smart devices.

20. The method of claim 18, wherein determining whether to install or uninstall the wearable device application on the wearable device further comprises:
displaying an install button when the queried installation status of the wearable device application is “not installed”; and
pushing the wearable device application to the wearable device and forcing the wearable device to install the wearable device application on the wearable device when the install button is clicked.

21. The wearable device of claim 18, wherein determining whether to install or uninstall the wearable device application on the wearable device further comprises:
displaying an uninstall button when the queried installation status of the wearable device application is “installed”; and
sending a request to the wearable device and forcing the wearable device to uninstall the wearable device application on the wearable device when the uninstall button is clicked.

22. A system for application management, including:
a smart device, providing an installation/uninstallation application package (APK) and transmitting the installation/uninstallation application package via a wireless transmission, wherein the installation/uninstallation application package further comprises an installation/uninstallation file corresponding to an application; and
a wearable device, receiving the installation/uninstallation application package from the smart device via the wireless transmission, parsing the installation/uninstallation application package to obtain the application installation/uninstallation file corresponding to the application, and using the application installation/uninstallation file to install/uninstall the application on the wearable device.

23. The system for application management of claim 22, further comprising:
after the application is completely installed/uninstalled, the wearable device returns an updated installation list to the smart device, so that the smart device synchronously updates the installation/uninstallation status of the application.

24. The system for application management of claim 22, further comprising:
during the application installation/uninstallation process, the wearable device returns an installation/uninstallation status for the application being installed/uninstalled to the smart device to simultaneously display an installation/uninstallation progress of the application on the smart device.
